(19) United States
(12) Patent Application Publication
(10) Pub. No.: US 2003/0147236 A1
(43) Pub. Date: Aug. 7, 2003

(54) Christmas tree structure of decorating lamp

(76) Inventor: Chih-Chen Chang, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/060,776

(22) Filed: Feb. 1, 2002

(51) Int. Cl. F21S 6/00; A41G 1/00

(52) U.S. Cl. 362/123; 428/18; 428/15; 362/252; 362/806

(57) ABSTRACT

The present invention is comprised of a proper number of segments, wherein each segment includes more than one palm-shaped branches, in which the cords is located and hidden on a core shaft by wrapping a belt to fasten a cluster of the needle-shaped leaves synchronously, or by binding a cluster of the needle-shaped leaves molded the cords into directly synchronously to construct a basic unit of the Christmas tree-shaped decorating lamp to meet the functions of improving whole valuation and facility of transportation.

### BACKGROUND OF THE INVENTION

1. Field of the Invention

The present invention relates to a Christmas tree structure of decorating lamp, and more particularly to a Christmas tree-shaped decorating lamp without exposed cord.

2. Description of Prior Art

In accordance with the conventional Christmas tree attached with decorating lamp, it is comprised of a string of decorating lamps, several branches and a main trunk, wherein said branches branch out from the main trunk in radial around, and said string of decorating lamps is put over the branches of a traditional Christmas tree around by the user self so that it demands much time and labor, especially the larger to be decorated, the more difficult to be encountered, and the bared cords of said string of the decorating lamps hung over the tree are exposed into the air so as to make the Christmas tree appear into a fearful mess especially in daytime, it not only affects the whole outward appearance, but also the value.

For overcoming this shortcoming, the inventor had invented a string of decorating lamps hiding cords into the tree's branches and trunk, which had been referred in application and obtained the permission of U.S. Pat. No.: 6,030,670 and Chinese Patent No.: CN97224263.5 and CN97884560.X, in which the shortcomings such like mess appearance caused by the exposed bared cords and taking too much time and labor by putting over the cords had been overcame at all, but that invention can not suit for locating a string of decorating lamps over an artificial Christmas tree, whether the conventional branches of the Christmas tree wrapped up by a needle-shaped leaves belt molded the twisted cords into, or by needle-shaped leaves molded the twisted cords into directly, they do not have a hollow inside for hiding the cords of said string of decorating lamps in.

### OBJECTS AND SUMMARY OF THE INVENTION

It is therefore a main object of the present invention to provide a Christmas tree structure of decorating lamp, which can hide most of cords so as to improve the goods outward appearance and valuation.

It is a next object of the present invention to provide a Christmas tree structure of decorating lamp, in which the string of decorating lamps can be pre-located on the branches for avoiding the trouble of putting over and wiring the cords by the user self.

It is a another object of the present invention to provide a Christmas tree structure of decorating lamp, in which a local connection unit is built coordinating to the number and position of said branch pre-attached with decorating lamps for plugging in or out so as to make store and transport more convenient.

The present invention is comprised of a proper number of segments, wherein each segment includes more than one palm-shaped branches, in which the cords is located and hidden on a core shaft by wrapping a belt to fasten a cluster of the needle-shaped leaves synchronously, or by binding a cluster of the needle-shaped leaves molded the cords into directly synchronously to construct a basic unit of the Christmas tree-shaped decorating lamp to meet the functions of improving whole valuation and facility of transportation.

### BRIEF DESCRIPTION OF THE DRAWINGS

FIG. 1 is a scheme showing a palm-shaped branch of the present invention.

FIG. 2 is a solid exploded view showing binding the cords and cluster of needle-shaped leaves on the core shaft of the palm-shaped branch of the present invention.

FIG. 3 is a solid view showing the palm-shaped branches in on a segment attaching on the main trunk in the first embodiment of the present invention.

FIG. 4 is a solid view showing a combined state in the first embodiment of the pre-sent invention.

FIG. 5 is a scheme showing the second embodiment of the present invention.

### DETAILED DESCRIPTION OF PREFERRED EMBODIMENTS

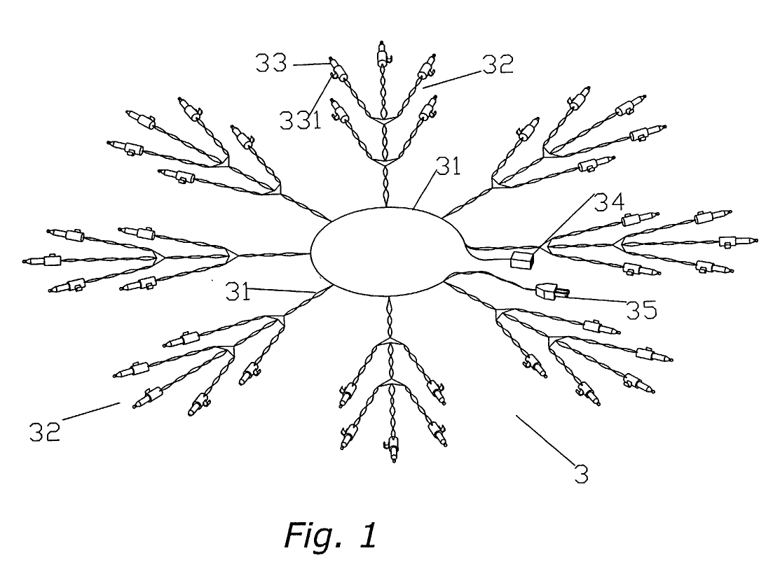

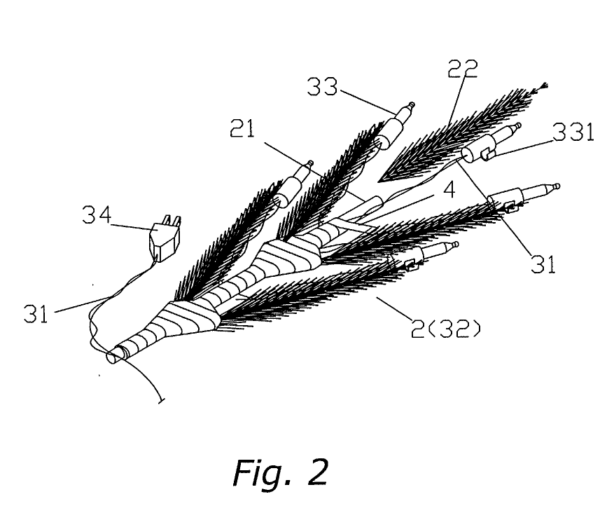

Referring to FIG. 1 and FIG. 2, several palm-shaped branches 32 are built on the cord 31 of a string of decorating lamps 3 provided by the present invention, wherein the shape of said palm-shaped branch 32 coordinates to the branch 2's about, and in its tip end a bulb 33 is connected in electric connection, and the lamp-holder of said bulb 33 has a retainer 331 for fastening on a cluster of the needle-shaped leaves 22, and the cords coordinating to the core shaft 21 of the branch is located and hidden by binding a belt 4 to fastening a cluster of the needle-shaped leaves on said core shaft 21 of said branch synchronously. Said cords 31 of the decorating lamps 3 has a couple of plug 34 and socket 35 connected on the both end separately for series connection, thereby extending said Christmas tree by adding more than one unit of said branch 2 in series connection to meet the necessary of length of said branch 2 in each segment.

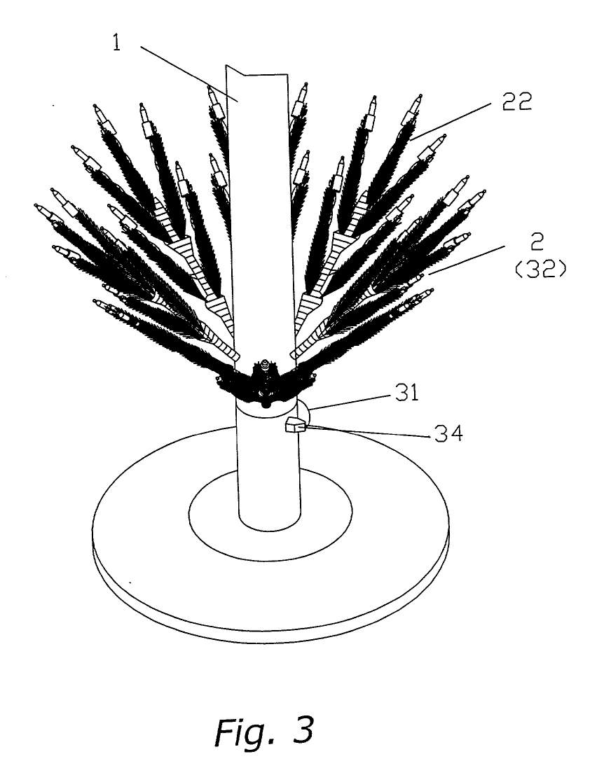

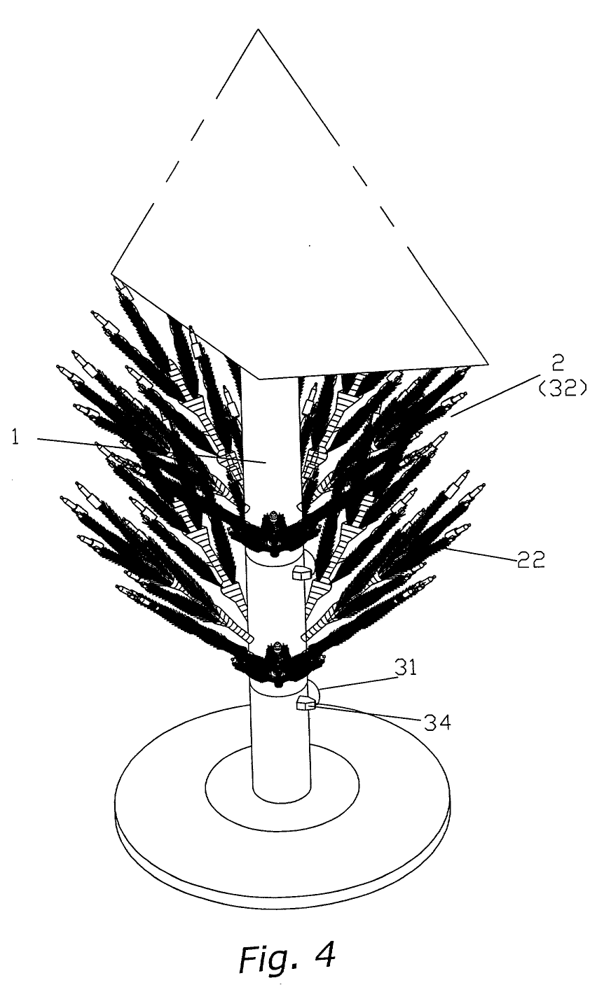

Referring to FIG. 3 and FIG. 4, the first embodiment of the present invention is shown, therein said palm-shaped branches 32 of said string of decorating lamps 3 are arranged in horizontal array around the trunk, and in stepped construction from the bottom to the top circularly and upward, or from the top to the bottom downward, but in each level said branch 2 is retained on said trunk 1 and the string of decorating lamps 3 of each level via the plug connecting with said cords 31 connect to the power source on said trunk 1, or the socket 35 located on the last level.

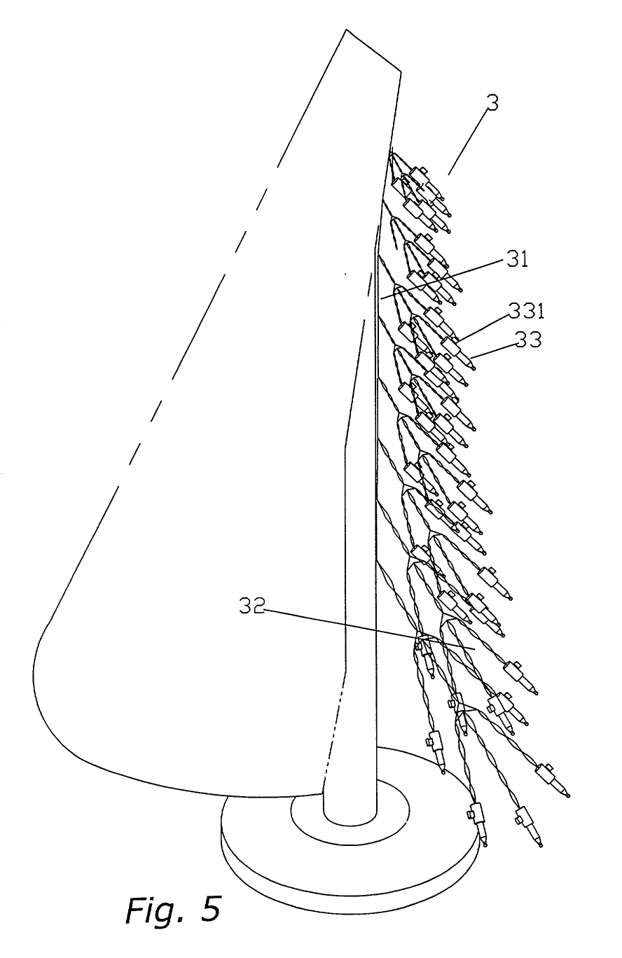

In the second embodiment shown in FIG. 5, said palm-shaped branches 32 of said string of decorating lamps 3 are arranged in vertical array along the trunk, each of them is retained on the different level but the same orientation on the branches 2, around the trunk different orientation's strings take the same way of location, and between them by the plugs 34 and the sockets 35 they are connected in series connection.

For concerning the convenience of knocked-down shipping and reinstalling of said branches 2 with said trunk 1, all or part of the palm-shaped branches 32 of said string of decorating lamps 3 in the same branch 2 consist of a local connection unit, or all or part in the same orientation consist of a local connection unit in the branch 2. Due to the local connection units, the whole tree can be taken apart as in shipping so that the production cost is reduced, and the user just need to reinstall every local connection unit following the diagram, then cut in the power source at all in the desired site.

Referring to FIG. 1 to FIG. 5, said lamp-holder holding said bulb 33 has a retainer 331 for fastening on the tip end of the cluster of the needle-shaped leaves 22, and the cords coordinating to the needle-shaped leaves 22 of said palm-shaped branch 32 can be hidden or hung over the bottom side said cluster of needle-shaped leaves 22.

I claim:

1. A Christmas tree structure of decorating lamp, comprised of strings of decorating lamps, branches and trunk, wherein said branches are arranged and located in lit-par-lit structure around the trunk, and the string of decorating lamps are located on the braches; the feather is in there: the cord part of said string of decorating lamp has more than one palm-shaped branches, coordinating to the branch in shape, and at the tip end a bulb is built on and connected in electric connection, and the cords coordinating to the core shaft of the branch is hidden synchronously as binding the clusters of needle-shaped leaves on the core shaft with a binding belt.

2. A Christmas tree structure of decorating lamp as claimed in claim 1, wherein, said string of decorating lamps has a couple of plug and socket built on the both ends separately.

3. A Christmas tree structure of decorating lamp as claimed in claim 1, wherein, said palm-shaped branches of said string of decorating lamps are arranged in horizontal array around the trunk, and in stepped construction from the bottom to the top circularly and upward, one terminal is connected to the power source.

4. A Christmas tree structure of decorating lamp as claimed in claim 1, wherein, said palm-shaped branches of said string of decorating lamps are arranged in horizontal array around the trunk, and in stepped construction from the top to the bottom circularly and downward, one terminal is connected to the power source.

5. A Christmas tree structure of decorating lamp as claimed in claim 1, wherein, said palm-shaped branches of said string of decorating lamps are arranged in vertical array along the trunk, each of them is retained on the different level but the same orientation on the branches, one terminal is connected to the power source.

6. A Christmas tree structure of decorating lamp as claimed in claim 3 or claim 4, wherein, in the connection of said palm-shaped branches and the branch, all or part of the palm-shaped branches of said strings of decorating lamps in the same branch consist of a local connection unit.

7. A Christmas tree structure of decorating lamp as claimed in claim 5, wherein, in the connection of said palm-shaped branches and the branch, all or part in the same orientation consist of a local connection unit in the branch.

8. A Christmas tree structure of decorating lamp as claimed in claim 1, wherein, said lamp-holder holding said bulb has a retainer for fastening on the tip end of the cluster of the needle-shaped leaves.
